(19) United States
(12) Patent Application Publication
(10) Pub. No.: US 2025/0115531 A1
(43) Pub. Date: Apr. 10, 2025

(54) FOOD PRODUCTION SYSTEM, COMPOSITIONS, AND METHODS OF USING THE SAME

(71) Applicant: ARIZONA BOARD OF REGENTS ON BEHALF OF ARIZONA STATE UNIVERSITY, Scottsdale, AZ (US)

(72) Inventors: Ivan Ermanoski, Tempe, AZ (US); James Miller, Albuquerque, NM (US); Ellen Stechel, Albuquerque, NM (US)

(21) Appl. No.: 18/933,740

(22) Filed: Oct. 31, 2024

Related U.S. Application Data
(63) Continuation-in-part of application No. 18/199,277, filed on May 18, 2023.
(60) Provisional application No. 63/343,248, filed on May 18, 2022.

(51) Int. Cl. C05G 5/40; A01G 18/20; A23L 31/00; C05C 9/00; C05D 9/02; C05G 3/50

(52) U.S. Cl. CPC C05G 5/40; A01G 18/20; A23L 31/00; C05C 9/005; C05D 9/02; C05G 3/50

(57) ABSTRACT

This invention is directed to systems, compositions, and methods of producing food.

This application is a Continuation-in-Part of U.S. patent application Ser. No. 18/199,277, filed on May 18, 2023, which claims priority from U.S. Provisional Application No. 63/343,248 filed on May 18, 2022, the entire contents of each of which are incorporated herein by reference.

All patents, patent applications and publications cited herein are hereby incorporated by reference in their entirety. The disclosures of these publications in their entireties are hereby incorporated by reference into this application in order to more fully describe the state of the art as known to those skilled therein as of the date of the invention described and claimed herein.

This patent disclosure contains material that is subject to copyright protection. The copyright owner has no objection to the facsimile reproduction by anyone of the patent document or the patent disclosure as it appears in the U.S. Patent and Trademark Office patent file or records, but otherwise reserves any and all copyright rights.

### FIELD OF THE INVENTION

This invention is directed to systems, compositions, and methods of producing food.

### BACKGROUND OF THE INVENTION

The human food system is photosynthesis-based. In other words, food calories consumed by humans today originate as plant (i.e., photosynthetic) matter/biomass. Examples are plant foods (e.g., grains, cereals, tubers, fruits, etc.), which are produced via the photosynthesis process, and account for the majority of the world's calorie intake. Photosynthetic biomass is used as feed for livestock or as substrate for fungi or forms the basis of the marine food chain-part of the human civilization food system. Whilst there is a perception that domestic animals are the most inefficient link in the human food chain, photosynthesis in plants is responsible for the majority of the energy loss going from sunlight to edible calories.

### SUMMARY OF THE INVENTION

Aspects of the invention are drawn towards an abiotic, nutrient-cultivating substrate comprising an abiotic carrier material and an abiotic nutrient mixture, wherein the abiotic nutrient mixture comprises: about 15 to about 65 grams of water per gram of carrier material; about 0.5% to about 10% of at least one abiotic carbon source per gram of water, wherein the abiotic carbon source is selected from the group consisting of a polyol, a polycarboxylic acid, an alkane emulsion, or a combination thereof; an abiotic nitrogen source present in a ratio of about 5:1 with the abiotic carbon source; a micronutrient source; and an agent and/or solution capable of maintaining the substrate at a pH of about 6 to about 8. In embodiments, the abiotic carrier material comprises a porous material. In embodiments, the porous material comprises mineral wool, zeolite, mesoporous metal oxides, fiberglass, perlite, vermiculite, a synthetic polymer, a polymer foam, or a combination thereof. In embodiments, the polymer foam is an open cell foam. In embodiments, the open cell foam comprises a polyurethane foam, a polyethylene foam, a polyvinylchloride foam, or a combination thereof. In embodiments, the polyol is selected from the group consisting of a polymeric polyol, a sugar alcohol, a diol, a triol, a tetrol, or any combination thereof. In embodiments, the polyol is selected from the group consisting of 1,3-propanediol, 1,3-butanediol, 1,4-butanediol, 1,5-pentanediol, 1,2,6-hexanetriol, propylene glycol, or a combination thereof. In embodiments, the polycarboxylic acid is selected from the group consisting of succinic acid, adipic acid, or a combination thereof. In embodiments, the alkane emulsion comprises mixture of alkanes and at least one emulsifier. In embodiments, the mixture of alkanes is selected from the group consisting of paraffin, mineral oil, or a combination thereof. In embodiments, the emulsifier comprises Behentrimonium Methosulfate Cetearyl Alcohol (BTMS 25). In embodiments, the nitrogen source comprises urea. In embodiments, the micronutrient source comprises an iron source, a phosphorus source, a calcium source, a potassium source, a magnesium source, a zinc source, a copper source, a manganese source, a boron source, or a combination thereof.

Aspects of the disclosure are drawn towards a nutrient production system comprising the abiotic carrier material described herein, the abiotic nutrient mixture described herein, and a metabolization source. In embodiments, the metabolization source comprises source comprises a saprophytic organism. In embodiments, the saprophytic organism comprises mold, mushroom, yeast, penicillium, and mucor, or a combination thereof. In embodiments, the mushroom is selected from the group consisting of Pleurotus ostreatus, Pleurotus pulmonarius, Pleurotus populinus, Ganoderma lucidum, Trametes versicolor, Grifola frondosa, Pleurotus columbinus, Pleurotus diamor, Pleurotus eryngii, Amillaria gallica, Cantharellus cibarius, Lentinula edodes, Auricularia auricula, Armillaria mellea, Polyporus squamosus, Hericium erinaceus, Polyporus umbellatus, Laetiporus sulphureus, or a combination thereof.

Aspects of the disclosure are drawn towards a method of producing an edible material without photosynthesis, the method comprising: producing the nutrient mixture described herein; soaking the abiotic carrier material of claim 1 in the nutrient mixture to create a cultivation substrate; and cultivating at least one saprophytic organism on the cultivation substrate, wherein the saprophytic organism metabolizes the cultivation substrate to produce a food product. In embodiments, the food product comprises the saprophytic organism, a derivative thereof, or a product thereof. In embodiments, the derivative or product thereof comprises an oil, a liquid, a gel, a powder, or a combination thereof.

Other objects and advantages of this invention will become readily apparent from the ensuing description.

### BRIEF DESCRIPTION OF THE FIGURES

The patent or application file contains at least one drawing executed in color. Copies of this patent or patent application publication with color drawing(s) will be provided by the Office upon request and payment of necessary fee.

FIG. 1 shows non-limiting, exemplary photographs of mycelium propagation. Pearl oyster (P. ostreatus) mycelium colonization from rye grain, on a substrate using 1,3 butanediol as the energy source (top row). The stagnation evident at days 82-96 reverses following additions of a 2% butanediol solution on days 98 and 105. The bottom row shows an otherwise identical preparation, without the diol, showing no evidence of colonization.

FIG. 2 shows non-limiting, exemplary photographs of mycelium propagation. Phoenix oyster (P. ostreatus) mycelium colonization from rye grain, on a substrate using 1,4 butanediol as the energy source. The stagnation evident at days 41-104 reverses following additions of a 2% butanediol solution on days 106, 112, and 115.

FIG. 3 shows non-limiting, exemplary photographs of mycelium propagation. The effect of polyol addition to an otherwise inactive culture. Following nearly 100 days of insignificant activity, mycelium rapidly colonizes the substrate after the addition of a 2.3% polyol mixture (1,3-propanediol, 1,3-butanediol, 1,4-butanediol, 1,5-pentanediol, and 1,2,6-hexanetriol).

FIG. 4 shows non-limiting, exemplary photographs of mycelium propagation. Examples of mycelial cultures colonizing hydrocarbon-based substrates: (Panel a) Propylene glycol 1%, (Panel b) 1,5-pentanediol 1.5%, (Panel c) 1,2,6-hexanetriol 2%, (Panel d) Alkane polyol mix 6.3%, (Panel e) Polyol mixture 1.67% (1,2,6-hexanetriol 0.5%, 1,3-propanediol 0.67%, 1,4-butanediol 0.5%), (Panel f) Alkanes 5%.

FIG. 5. shows a non-limiting, exemplary graph of total carbon exhaled as CO₂ and corresponding rate, for Phoenix oyster (P. ostreatus) mycelium colonizing a 1,3-propanediol substrate. Note the general rate increase as the mycelium grows. To compensate for the used diol and water, the substrate was periodically replenished with a 3% propanediol solution and water as indicated.

### DETAILED DESCRIPTION OF THE INVENTION

Aspects of the invention are drawn towards optimization of a non-photosynthetic food system which can produce food for human and animal consumption without the use of photosynthesis.

Detailed descriptions of one or more preferred embodiments are provided herein. It is to be understood, however, that the present invention can be embodied in various forms. Therefore, specific details disclosed herein are not to be interpreted as limiting, but rather as a basis for the claims and as a representative basis for teaching one skilled in the art to employ the present invention in any appropriate manner.

The singular forms “a”, “an” and “the” include plural reference unless the context clearly dictates otherwise. The use of the word “a” or “an” when used in conjunction with the term “comprising” in the claims and/or the specification can mean “one,” but it is also consistent with the meaning of “one or more,” “at least one,” and “one or more than one.”

Wherever any of the phrases “for example,” “such as,” “including” and the like are used herein, the phrase “and without limitation” is understood to follow unless explicitly stated otherwise. Similarly, “an example,” “exemplary” and the like are understood to be nonlimiting.

The term “substantially” allows for deviations from the descriptor that do not negatively impact the intended purpose. Descriptive terms are understood to be modified by the term “substantially” even if the word “substantially” is not explicitly recited.

The terms “comprising” and “including” and “having” and “involving” (and similarly “comprises”, “includes,” “has,” and “involves”) and the like are used interchangeably and have the same meaning. Specifically, each of the terms is defined consistent with the common United States patent law definition of “comprising” and is therefore interpreted to be an open term meaning “at least the following,” and is also interpreted not to exclude additional features, limitations, aspects, etc. Thus, for example, “a process involving steps a, b, and c” means that the process includes at least steps a, b and c. Wherever the terms “a” or “an” are used, “one or more” is understood, unless such interpretation is nonsensical in context.

As used herein the term “about” is used herein to mean approximately, roughly, around, or in the region of. When the term “about” is used in conjunction with a numerical range, it modifies that range by extending the boundaries above and below the numerical values set forth. In general, the term “about” is used herein to modify a numerical value above and below the stated value by a variance of 20 percent up or down (higher or lower).

### Non-Biomass Food System & Products Thereof

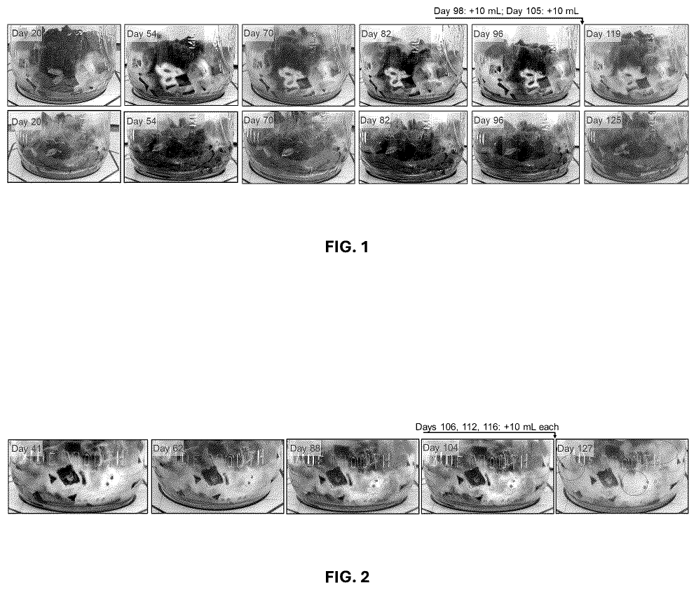

Aspects of the invention are directed towards a non-photosynthetic food system (see FIG. 1). As used herein, the term “non-photosynthetic” can refer to not involving or not requiring photosynthesis. As used herein, the term “photosynthesis” can refer to the process by which plants and organisms use sunlight to synthesize foods (e.g., glucose) from carbon dioxide and water. For example, photosynthesis can convert light energy into chemical energy. For example, plants and other organisms can convert carbon dioxide, water, and inorganic salts into carbohydrates, proteins, protein fragments, etc. In embodiments, non-photosynthetic can refer to converting water, carbon dioxide, and/or other inorganically/abiotically and/or non-biomass sourced compounds into carbohydrates, nutrients, and/or food without employing photosynthesis. As used herein, the term “non-photosynthetically derived” can refer to a process or substance that does not require photosynthesis.

Aspects of the invention are drawn towards a non-biomass food system. As used herein, the term “biomass” can refer to carbonaceous material derived from modern living organisms (e.g., living within the past 100 years), comprising plant-based biomass and animal-based biomass. As used herein, the term “modern living organisms” can refer to organisms that were living within about the last 100 years. For example, biomass does not include fossil-based carbonaceous materials such as coal, petroleum, petroleum products, natural gas, or a combination thereof. As used herein, the term “non-biomass” can refer to carbonaceous materials not encompassed by the term “biomass” as described herein. For example, non-biomass comprises anthracite, bituminous coal, subbituminous coal, lignite, petroleum coke, asphaltenes, petroleum, natural gas, petroleum products, liquid petroleum residues, or combinations thereof. As used herein, the term “organic” can refer to a substance derived from living organisms. As used herein, the terms “abiotic” can refer to a substance not consisting of or deriving from modern living matter (e.g., living within the past 100 years). As used herein, the term “modern living matter” can refer to material that was living within about the last 100 years. As used herein, abiotic compounds described herein can refer to compounds which contain carbons and/or carbon-hydrogen bonds but are not derived from modern living matter. In embodiments, abiotic compounds described herein can refer to compounds that contain carbon and/or carbon-hydrogen bonds or compounds that do not contain carbon and/or carbon-hydrogen bonds if they are not derived from modern living matter (e.g., living within the past 100 years).

Aspects of the invention are drawn towards a non-photosynthetic food system. As used herein, the terms “food system” and “system” can be used interchangeably. As used herein, the term “food system” can refer to compositions, processes, and products thereof for cultivating, generating, and/or producing food. As used herein, the term “food” can refer to a substance that is ingested, drank, eaten, or otherwise taken into the body to sustain life, provide energy, and/or promote growth. As used herein, the terms “food” and “nutrient” can be used interchangeably. For example, the term “nutrient” can refer to a substance that can be used by an organism to survive, grow, and/or reproduce.

Aspects of the invention are drawn towards a food system which utilizes a non-photosynthetically derived nutrient-cultivating substrate. Aspects of the invention are drawn towards a food system which utilizes a non-biomass nutrient-cultivating substrate. As used herein, the terms “nutrient-cultivating substrate”, “substrate”, “nutrient substrate”, and “cultivating substrate” can be used interchangeably. As used herein, the term “derive” can refer to producing or obtaining from a source. For example, derive can refer to receiving or obtaining from a source or origin. In embodiments, deriving can comprise conducting a chemical reaction or series of chemical reactions. As used herein, the term “non-photosynthetically derived” can refer to any product of a process that does not involve or require photosynthesis. As used herein, the term “non-biomass” derived can refer to any product of a process that does not involve and/or require biomass. In embodiments, the food system comprises an abiotic carrier material, a non-biomass carrier material, a non-biomass nutrient mixture, an abiotic nutrient mixture, a metabolization source, or a combination thereof.

As used herein, the term “substrate” can refer to a material, platform, or medium for a process or system. For example, the process is food cultivation. For example, the substrate can be used to cultivate food. In embodiments, the substrate comprises an abiotic carrier material, a non-biomass carrier material, a non-biomass nutrient mixture, an abiotic nutrient mixture, or a combination thereof.

As used herein, the term “carrier material” can refer to a material which provides an environment for inoculants (e.g., saprophytic organisms) to grow and/or cultivate. In embodiments, the carrier material can comprise a porous material. In embodiments, the carrier material can comprise a non-porous material. As used herein, the term “porous” can refer to possessing pores and/or possessing void space. In embodiments, porous can refer to a material that can be permeable by air or water. As used herein, the term “porosity” can refer to the fraction of void space within a porous article. In embodiments, the carrier material can comprise a high-surface area material. As used herein, the term “surface area” can refer to the total area the surface of an object occupies. In embodiments, the material can comprise a high surface area per unit of material. As used herein, the term “surface area” can refer to “specific surface area”. For example, “specific surface area” can refer to the surface area of a material per unit of mass. As used herein, the term “high surface area” can refer to about 0.1 m²/g to about 100 m²/g. In embodiments, surface area can be determined by Brunauer-Emmett-Teller (BET) surface area analysis. For example, the carrier material can provide a high-surface area environment to hold nutrients and water in a dispersed state. In embodiments, the porosity can be open porosity. As used herein, the term “open porosity” can refer to interconnected pores. For example, the interconnected pores can communicate with one another. In embodiments, the carrier material can absorb the nutrients and water.

As used herein the term “abiotic” can refer to not comprising of or being derived from modern living matter. As used herein, the terms “inorganic” and “abiotic” can be used interchangeably. Herein, the carrier material described can be inorganic or abiotic. Herein, the carrier material can be non-biomass substance. As used herein, the term “non-biomass substance” can refer to a material that is not produced from modern living organisms (e.g., living within the past 100 years), comprising plant-based biomass and animal-based biomass. Herein, the carrier material can be abiotic. As used herein, the term “abiotic” can refer to a non-living material. In embodiments, the carrier material comprises mineral wool, zeolite, mesoporous metal oxides, fiber glass, vermiculite, pumice, a synthetic polymer, or another porous, abiotic material. In embodiments the synthetic polymer comprises an inorganic polymer, an organic polymer, or a copolymer thereof. In embodiments, the polymer comprises a fluoropolymer, a polyanhydride, a polyketone, a polyester, a polyolefin, a vinyl polymer, or a combination thereof. In embodiments, the polymer comprises a polyethylene, a polyurethane, a polypropylene, a polystyrene, a polyvinyl chloride, a synthetic rubber, a neoprene, a nylon, a polyacrylonitrile, a silicone, a phenol formaldehyde resin, a polyvinyl butyral, or a copolymer thereof.

As used herein, the term “abiotic” can refer to a factor or component that is not derived from modern living organisms (e.g., living within the past 100 years). As used herein, the term “abiotic nutrient mixture” can refer to a nutrient mixture that is not derived from modern living organisms (e.g., living within the past 100 years).

In embodiments, the abiotic nutrient mixture comprises water and at least one synthetically produced and/or non-biomass carbon source. In embodiments, the carbon source comprises a carbon-containing compound, a carbon-containing composition, or a combination thereof. In embodiments, the abiotic nutrient mixture comprises non-biomass nutrients. For example, the non-biomass nutrients can comprise vanillin, potash, diammonium phosphate, urea, peptone, a boron source, a calcium source, a copper source, an iron source, a magnesium source, a manganese source, a zinc source, or any combination thereof. For example, the non-biomass nutrients can be obtained through mining. As used herein, the term “synthetically produced” can refer to anything produced artificially. As used herein, the term “artificially” can refer to something that occurs by means of human intervention rather than occurring naturally. For example, synthetically produced can refer to something that is produced by chemical synthesis or a chemical reaction.

In embodiments, the carbon source can refer to a hydrocarbon, an alcohol, carboxylic acid, a carbohydrate, an amide, an amine, an aldehyde, a polyol, an alkane, an alkene, an alkyne, an ether, an ester, a ketone, a carbohydrate, or a combination thereof. In embodiments, the alkane comprises n-alkanes. In embodiments, the alkanes can comprise CₓH_{y} wherein x=about 20 to about 40 and wherein y=about 42 to about 82. In embodiments, the n-alkane comprises n-icosane, n-heneicosane, n-docosane, n-tricosane, n-tetracosane, n-pentacosane, n-hexacosane, n-heptacosane, n-octacosane, n-nonacosane, n-triacontane, n-hentriacontane, n-dotriacontane, n-tritriacontane, n-tetratriacontane, n-pentatriacontane, n-hexatriacontane, n-heptatriacontane, n-octatriacontane, n-nonatriacontane, and n-tetracontane. In embodiments, the carbon source comprises paraffin, mineral oil (baby oil), petroleum, and petroleum products. As used herein, paraffin can comprise a mixture of n-alkanes. In embodiments, the carbon-containing compound can be derived from a non-biomass source, an abiotic carbon source, a non-biomass hydrogen source, an abiotic hydrogen source, an abiotic nitrogen source, a non-biomass nitrogen source, or a combination thereof. For example, the abiotic carbon source can be CO, CO₂, carbonates, carbonic salts, or any combination thereof. As used herein, the term “abiotic carbon” can refer to carbon that is not derived from living and/or organic sources. For example, the carbon is derived from a reaction of abiotic compounds. For example, the carbon is extracted from ores and minerals. In embodiments, the carbon is derived from a non-biomass source. As used herein, the term “non-biomass carbon” can refer to carbon which is not derived from derived from modern living organisms (e.g., within the past 100 years), comprising plant-based biomass and animal-based biomass. For example, the carbon source is derived from petroleum or coal. For example, the carbon source comprises graphene, xylitol, mannitol, maltitol, sorbitol, propylene glycol, ethylene glycol, and hydroquinone. Non-limiting examples of carbon are carbon oxides such as carbon monoxide and carbon dioxide; polyatomic ions, cyanide, cyanate, thiocyanate, carbonate and carbide in carbon. In embodiments, the abiotic carbon source is derived from carbon dioxide, carbon monoxide, cyanide, cyanate, carbonate, a carbon allotrope, or a combination thereof.

In embodiments, the carbon source comprises less than about 0.0001%, about 0.0001%, about 0.0025%, about 0.003%, about 0.004%, about 0.00 5%, about 0.006%, about 0.00 7%, about 0.008%, about 0.009%, about 0.010%, about 0.015%, about 0.02%, about 0.025%, about 0.03%, about 0.035%, about 0.04%, about 0.045%, about 0.05%, about 0.055%, about 0.06%, about 0.065%, about 0.07%, about 0.075%, about 0.08%, about 0.085%, about 0.09%, about 0.095%, about 0.1%, about 0.15%, about 0.2%, about 0.25%, about 0.3%, about 0.35%, about 0.4%, about 0.45%, about 0.5%, about 0.55%, about 0.6%, about 0.65%, about 0.7%, about 0.75%, about 0.8%, about 0.85%, about 0.9%, about 0.95%, about 1.0%, about 1.1%, about 1.2%, about 1.3%, about 1.4%, about 1.5%, about 1.6%, about 1.7%, about 1.8%, about 1.9%, about 2.0%, about 2.1%, about 2.2%, about 2.3%, about 2.4%, about 2.5%, about 2.6%, about 2.7% about 2.8%, about 2.9%, about 3.0%, about 3.1%, about 3.2%, about 3.3%, about 3.4%, about 3.5%, about 3.6%, about 3.7%, about 3.8%, about 3.9%, about 4.0%, about 4.1%, about 4.2%, about 4.3%, about 4.4%, about 4.5%, about 5%, about 6%, about 7%, about 8%, about 9%, about 10%, about 11%, about 12%, about 13%, about 14%, about 15%, about 20%, about 21%, about 22%, about 23%, about 24%, about 25%, or greater than about 25% of the water in the nutrient mixture.

In embodiments, the nutrient mixture comprises a nitrogen source. In embodiments, the nitrogen source is non-biomass nitrogen source. For example, the non-biomass nitrogen source comprises a nitrogen containing compound or nitrogen containing composition. For example, the non-biomass nitrogen source can comprise urea, diammonium phosphate, ammonia, ammonium citrate, ammonium nitrate, potassium nitrate, or a combination thereof. In some embodiments, the media can be supplemented with peptone. In embodiments, the nitrogen source can be derived from dinitrogen. In embodiments, abiotic hydrogen source can be derived from water.

In embodiments, the nitrogen source comprises less than about 0.0001%, about 0.0001%, about 0.0025%, about 0.003%, about 0.004%, about 0.00 5%, about 0.006%, about 0.00 7%, about 0.008%, about 0.009%, about 0.010%, about 0.015%, about 0.02%, about 0.025%, about 0.03%, about 0.035%, about 0.04%, about 0.045%, about 0.05%, about 0.055%, about 0.06%, about 0.065%, about 0.07%, about 0.075%, about 0.08%, about 0.085%, about 0.09%, about 0.095%, about 0.1%, about 0.15%, about 0.2%, about 0.25%, about 0.3%, about 0.35%, about 0.4%, about 0.45%, about 0.5%, about 0.55%, about 0.6%, about 0.65%, about 0.7%, about 0.75%, about 0.8%, about 0.85%, about 0.9%, about 0.95%, about 1.0%, about 1.1%, about 1.2%, about 1.3%, about 1.4%, about 1.5%, about 1.6%, about 1.7%, about 1.8%, about 1.9%, about 2.0%, about 2.1%, about 2.2%, about 2.3%, about 2.4%, about 2.5%, about 2.6%, about 2.7% about 2.8%, about 2.9%, about 3.0%, about 3.1%, about 3.2%, about 3.3%, about 3.4%, about 3.5%, about 3.6%, about 3.7%, about 3.8%, about 3.9%, about 4.0%, about 4.1%, about 4.2%, about 4.3%, about 4.4%, about 4.5%, about 5%, about 6%, about 7%, about 8%, about 9%, about 10%, about 11%, about 12%, about 13%, about 14%, about 15%, about 20%, about 21%, about 22%, about 23%, about 24%, about 25%, or greater than about 25% of the carbon source by atom count.

In embodiments, the one or more carbon sources can be used as the only carbon source by the metabolization sources described herein. In some embodiments, the non-biomass and/or abiotic carbon-containing compounds can be used in combination with other carbon sources in the systems disclosed herein.

In embodiments, the carbon source can be derived from a chemical reaction or series thereof. For example, the carbon source can be produced from a carbon producing reaction or a combination of carbon producing reactions and additional reactions to generate compounds comprising carbon, oxygen, hydrogen, and/or nitrogen. For example, the chemical reaction or series thereof can comprise Fischer-Tropsch process, Sabatier reaction, Methanation, Haber-Bosch process, water splitting, CO₂ splitting, Birkeland-Eyde process, a nitrogen fixation process, or a carbon fixation process. In embodiments, the carbon source is generated from a reaction or series of reactions that can generate a carbon-containing compound from an abiotic source.

In embodiments, if hydrocarbons are available, they can be used with or without further reactions. In embodiments, the hydrocarbons can be petroleum products and/or petroleum byproducts.

In embodiments, the non-biomass and/or synthetically produced carbon source can comprise propylene glycol, paraffin, n-icosane, n-henicosane, n-docosane, n-tricosane, n-tetracosane, n-pentacosane, n-hexacosane, n-heptacosane, n-octacosane, n-nonacosane, n-triacontane, n-hentriacontane, n-dotriacontane, n-tritriacontane, n-tetratriacontane, n-pentatriacontane, n-hexatriacontane, n-heptatriacontane, n-octatriacontane, n-nonatriacontane, and n-tetracontane.

In embodiments, the nutrient mixture can further comprise a micronutrient source. For example, the micronutrient source can comprise a micronutrient mixture, an individual micronutrient, or a combination thereof. As used herein, the term “micronutrient” can refer to vitamins and minerals. As used herein, the terms “micronutrient” and “mineral” can be used interchangeably. As used herein, the term “mineral” can refer to a compound or a composition. In embodiments, the micronutrient can comprise one or more abiotic species. For example, micronutrient can comprise calcium, phosphorus, potassium, sodium, chloride, magnesium, iron, zinc, iodine, sulfur, cobalt, copper, fluoride, manganese, selenium, or any compound containing an atom or ion thereof. In embodiments, the micronutrient can comprise triple superphosphate, iron, phosphorus, potassium, potash, or a combination thereof.

In some embodiments, the micronutrient mixture can comprise less than about 0.001%, about 0.001%, about 0.05%, about 0.1%, about 0.15%, about 0.2%, about 0.25%, about 0.3%, about 0.35%, about 0.4%, about 0.45%, about 0.5%, about 0.55%, about 0.6%, about 0.65%, about 0.7%, about 0.75%, about 0.8%, about 0.85%, about 0.9%, about 0.95%, about 1.0%, about 1.1%, about 1.2%, about 1.3%, about 1.4%, about 1.5%, about 1.6%, about 1.7%, about 1.8%, about 1.9%, about 2.0%, about 2.1%, about 2.2%, about 2.3%, about 2.4%, about 2.5%, about 2.6%, about 2.7% about 2.8%, about 2.9%, about 3.0%, about 3.1%, about 3.2%, about 3.3%, about 3.4%, about 3.5%, about 3.6%, about 3.7%, about 3.8%, about 3.9%, about 4.0%, about 4.1%, about 4.2%, about 4.3%, about 4.4%, about 4.5%, about 5%, about 6%, about 7%, about 8%, about 9%, about 10%, about 11%, about 12%, about 13%, about 14%, about 15%, about 20%, about 21%, about 22%, about 23%, about 24%, about 25%, or greater than about 25% of the elements contained in the micronutrient mixture.

In embodiments, the micronutrient mixture can comprise less than about 0.0001%, about 0.0001%, about 0.0025%, about 0.003%, about 0.004%, about 0.00 5%, about 0.006%, about 0.00 7%, about 0.008%, about 0.009%, about 0.010%, about 0.015%, about 0.02%, about 0.025%, about 0.03%, about 0.035%, about 0.04%, about 0.045%, about 0.05%, about 0.055%, about 0.06%, about 0.065%, about 0.07%, about 0.075%, about 0.08%, about 0.085%, about 0.09%, about 0.095%, about 0.1%, about 0.15%, about 0.2%, about 0.25%, about 0.3%, about 0.35%, about 0.4%, about 0.45%, about 0.5%, about 0.55%, about 0.6%, about 0.65%, about 0.7%, about 0.75%, about 0.8%, about 0.85%, about 0.9%, about 0.95%, about 1.0%, about 1.1%, about 1.2%, about 1.3%, about 1.4%, about 1.5%, about 1.6%, about 1.7%, about 1.8%, about 1.9%, about 2.0%, about 2.1%, about 2.2%, about 2.3%, about 2.4%, about 2.5%, about 2.6%, about 2.7% about 2.8%, about 2.9%, about 3.0%, about 3.1%, about 3.2%, about 3.3%, about 3.4%, about 3.5%, about 3.6%, about 3.7%, about 3.8%, about 3.9%, about 4.0%, about 4.1%, about 4.2%, about 4.3%, about 4.4%, about 4.5%, about 5%, about 6%, about 7%, about 8%, about 9%, about 10%, about 11%, about 12%, about 13%, about 14%, about 15%, about 20%, about 21%, about 22%, about 23%, about 24%, about 25%, or greater than about 25% of the water in the nutrient mixture by weight.

In embodiments, the nutrient mixture can further comprise a promoter. As used herein, the term “promoter” can refer to a growth promoter. For example, the promoter can increase size, amount, and development of a metabolization source described herein. The promoter described herein can encompass any non-biomass compound or composition that increases the size, amount, and/or development of metabolization source and/or food product. In some embodiments, the promoter can comprise vanillin, iron, or a combination thereof. For example, the vanillin can comprise a synthetically produced vanillin.

In embodiments, the promoter can comprise less than about 0.0001%, about 0.0001%, about 0.0025%, about 0.003%, about 0.004%, about 0.00 5%, about 0.006%, about 0.00 7%, about 0.008%, about 0.009%, about 0.010%, about 0.015%, about 0.02%, about 0.025%, about 0.03%, about 0.035%, about 0.04%, about 0.045%, about 0.05%, about 0.055%, about 0.06%, about 0.065%, about 0.07%, about 0.075%, about 0.08%, about 0.085%, about 0.09%, about 0.095%, about 0.1%, about 0.15%, about 0.2%, about 0.25%, about 0.3%, about 0.35%, about 0.4%, about 0.45%, about 0.5%, about 0.55%, about 0.6%, about 0.65%, about 0.7%, about 0.75%, about 0.8%, about 0.85%, about 0.9%, about 0.95%, about 1.0%, about 1.1%, about 1.2%, about 1.3%, about 1.4%, about 1.5%, about 1.6%, about 1.7%, about 1.8%, about 1.9%, about 2.0%, about 2.1%, about 2.2%, about 2.3%, about 2.4%, about 2.5%, about 2.6%, about 2.7% about 2.8%, about 2.9%, about 3.0%, about 3.1%, about 3.2%, about 3.3%, about 3.4%, about 3.5%, about 3.6%, about 3.7%, about 3.8%, about 3.9%, about 4.0%, about 4.1%, about 4.2%, about 4.3%, about 4.4%, about 4.5%, about 5%, about 6%, about 7%, about 8%, about 9%, about 10%, about 11%, about 12%, about 13%, about 14%, about 15%, about 20%, about 21%, about 22%, about 23%, about 24%, about 25%, or greater than about 25% of the water by weight in the nutrient mixture.

In embodiments, the nutrient mixture further comprises an emulsifier. As used herein, the term “emulsifier” can refer to an additive which can promote the formation and stabilization of an emulsion. In embodiments, the emulsifier can comprise any non-biomass emulsifier. For example, the emulsifier can comprise a compound with an HLB value of about 3 to about 18. For example, the emulsifier can comprise any emulsifier known in the art. For example diethylene glycol, propylene glycol monocaproate, propylene glycol monocaprylate, propylene glycol monocaprate, propylene glycol monolaurate, propylene glycol monostearate, propylene glycol monopalmitate, polyethylene glycol lauryl ether, polyethylene glycol oleyl ether, polyethylene glycol hexadecyl ether, sorbitan monopalmitate, sorbitan monostearate, sorbitan monooleate, sorbitan monolaurate, transcutol P, gelucire 50/13, gelucire 44/14, gelucire 43/01, lecithin, cetearyl alcohol, fatty acid esters, caprylocaproyl polyoxyl-8 glycerides, macrogolglycerol ricinoleate, behentrimonium methosulfate (BTMS), or a combination thereof.

In embodiments, the emulsifier can be present in the nutrient mixture in less than about 0.1%, about 0.1%, about 0.2%, about 0.3%, about 0.4%, about 0.5%, about 0.6%, about 0.7%, about 0.8%, about 0.9%, about 1%, about 1.5%, about 2%, about 2.5%, about 3%, about 3.5%, about 4%, about 4.5%, about 5%, about 5.5%, about 6%, about 6.5%, about 7%, about 7.5%, about 8%, about 8.5%, about 9%, about 9.5%, about 10%, about 11%, about 12%, about 13%, about 14%, about 15%, about 16%, about 17%, about 18%, about 19%, about 20%, or greater than about 20% of the hydrocarbons by weight.

In embodiments, the nutrient mixture can comprise a solution for regulating and/or maintaining the pH of the composition. In embodiments, the nutrient mixture can comprise an agent for regulating and/or maintaining the pH. For example, the agent or solution can maintain the pH of the composition at about pH 6 to about pH 8. For example, the solution can be an acidifier. For example, the acidifier can comprise any composition that can acidify a solution. For example, the acidifier can comprise ferrous sulfate, a solution, or a combination thereof. For example, the solution can have a pH of about 7. For example, the solution can comprise water, potassium phosphate monobasic, sodium hydroxide, hydrogen chloride, in any amount or any combination thereof. For example, the solution can comprise about 99.15% water, about 0.72% potassium phosphate monobasic, and about 0.133% sodium hydroxide. For example, the solution can comprise about 98.5% water and about 1.5% HCl. For example, the solution can comprise about 3.125% to about 15.625% of the water weight of the nutrient mixture. For example, the solution can comprise about 1,111% to about 5,555% of the nitrogen content. For example, the HCl solution can comprise about 0.1% to about 1% of the water weight of the nutrient mixture. For example, the HCl solution can comprise about 38.28% to about 382.79% of the nitrogen content. For example, the ferrous sulfate comprises ferrous sulfate heptahydrate. In some embodiments, the solution can comprise a buffer solution. For example, the buffer solution can have a pH of 7. For example, the solution for regulating the pH of the composition can comprise a buffer.

In embodiments, the substrate comprises a carbon to nitrogen (C:N) ratio of about less than about 20:0.01, about 20:0.01, about 20:0.1, about 20:1, about 23:1, about 25:1, about 30:1, about 35:1, about 40:1, about 45:1, about 50:1, about 55:1, about 60:1, about 65:1, about 70:1, about 75:1, about 80:1, about 85:1, about 90:1, about 95:1, about 100:1, about 105:1, about 110:1, about 115:1, about 120:1, about 125:1, about 150:1, about 175:1, about 180:1, about 200:1, about 225:1, about 250:1, about 275:1, about 300:1, about 325:1, about 350:1, about 375:1, about 400:1, about 425:1, about 450:1, about 475:1, about 500:1, about 550:1, about 600:1, about 650:1, about 700:1, about 750:1, about 800:1, about 850:1, about 900:1, about 950:1, about 1000:1, about 1050:1, about 1100:1, about 1150:1, about 1200:1, about 1250:1, about 1300:1, about 1350:1, about 1400:1, about 1500:1, about 1600:1, about 1700:1, about 1800:1, about 1900:1, about 2000:1, about 2500:1, about 3000:1, about 3500:1, about 4000:1, about 4500:1, about 5000:1, or greater than 5000:1.

For example, the substrate can comprise about 48.38% paraffin, about 42.33% water, about 8.47 mineral wool, about 0.45% urea, about 0.28% micronutrients, about 0.08% potash, and about 0.01% diammonium phosphate. For example, the substrate can comprise about 48.12% paraffin, about 42.10% water, about 8.42% miner wool, about 0.99% ammonium sulfate, about 0.28% micronutrients, about 0.08% muriate of potash, and about 0.01% diammonium phosphate. For example, the substrate can comprise about 66% water, about 17% mineral wool, about 7% peptone, about 8% propylene glycol, and wherein the remaining about 2% comprises micronutrients, potash, triple superphosphate, or a combination thereof. For example, the substrate can comprise about 66.39% water, about 17.12% mineral wool, about 0.58% micronutrients, about 0.16% potash, about 0.03% triple superphosphate, about 7.44% peptone, and about 8.29% propylene glycol. In embodiments, the ranges described herein can vary by about 25%. In embodiments, the nitrogen containing compounds can be increased or decreased by about a factor of 10.

Aspects of the invention are drawn towards a metabolization source in the food system. As used herein, the terms “metabolization source” and “metabolism source” can be used interchangeably. In embodiments, the metabolism source can metabolize the cultivation substrate or portion thereof to create a food product. As used herein, the term “metabolization source” can refer to a source of metabolism. As used herein, the term “metabolism” can refer to the sum of physical and chemical processes in an organism by which its material substance is produced, maintained, and destroyed, and by which energy is made available. For example, metabolism can refer to chemical reactions which convert a substrate into energy. For example, the metabolization source can convert a substrate into food and/or nutrients.

In embodiments, the metabolism source can comprise saprophytic organisms. As used herein, the terms “saprophytic organism” and “saprophytes” can be used interchangeably. As used herein, the term “saprophyte” can refer to an organism which can obtain nutrients by absorbing dissolved organic material. For example, the saprophytic organism can comprise mold, mushroom, yeast, penicillium, and mucor, or a combination thereof. For example, the mushroom can comprise an oyster mushroom, Pleurotus ostreatus, Pleurotus pulmonarius, Ganoderma lucidum, Pleurotus columbinus, Pleurotus diamor, Pleurotus eryngii, Amillaria gallica, Cantharellus cibarius, honey mushroom, white-rot fungi, Lentinula edodes, or a shiitake mushroom. In some embodiments, saprophytes can comprise certain fungi, bacteria or archaeans. In embodiments, a saprophytic organism can metabolize a substrate described herein to generate food or nutrients. For example, a saprophytic organism can metabolize a non-biomass substrate described herein and be consumed as food or nutrients. For example, a saprophytic organism can metabolize a substrate and produce a compound to be consumed as food or nutrients. In embodiments, the carbon-containing compounds in the abiotic nutrient mixture can comprise paraffin, mineral oil (baby oil), or a combination thereof. In embodiments, proportions in of elements in the nutrient mixture can be selected based upon the saprophytic organism. In embodiments, the saprophytic organism can be further adapted to increase yields and/or nutritional quality on the substrate. For example, the adaptations can comprise selective breeding and/or genetic modifications.

Aspects of the invention are drawn towards formulations for producing food from a non-biomass food system. Non-limiting, exemplary examples of formulations can be found in Table 1.

Aspects of the invention are drawn towards products of a non-biomass and/or non-photosynthetic food system. In embodiments, the non-photosynthetic food comprises a non-biomass and/or abiotic food or nutrient. In embodiments, a metabolism source described herein can metabolize a cultivation substrate described herein to create a food or nutrition product. For example, the metabolism source can be consumed as food. For example, the metabolism source can be prepared and/or processed to produce an extract. As used herein, the term “extract” can refer to a substance made by extracting a raw material or part thereof. For example, the raw material can comprise a saprophytic organism or a part thereof. In embodiments, the extract can be produced by any extraction method known in the art. For example, the extraction methods comprises maceration, infusion, percolation, decoction, Soxhlet extraction, hot continuous extraction, microwave-assisted extraction (MAE), ultrasound-assisted extraction (UAE), sonication extraction, solvent extraction, accelerated solvent extraction (ASE), supercritical fluid extraction (SFE), enzyme-assisted extraction (EAE), extraction of volatile organic compounds, purge and trap (dynamic headspace), and solid phase microextraction. For example, the extract can comprise oils. For example, the oils can comprise mushroom-derived oils and/or yeast-derived oils. For example, the extract can comprise powders. For example, the powders can comprise mushroom-derived powders and/or yeast-derived powders.

### Methods

Aspects of the invention are directed towards methods of producing a food product without the using of biomass. Aspects of the invention are directed towards methods of producing a food product without the use of photosynthesis. In embodiments, the method comprises producing a nutrient mixture as described herein. For example, the nutrient mixture comprises a non-biomass carbon source and/or a synthetically produced carbon sources as described herein. In embodiments, a carrier material is soaked in the nutrient mixture to produce a cultivation substrate as described herein. In further embodiments, at least one saprophytic organism is cultivated on the cultivation substrate, wherein the saprophytic organism metabolizes the cultivation substrate or portion thereof to create a food product.

Aspects of the invention are drawn towards preparing a substrate. In embodiments, a substrate can be prepared by soaking a non-biomass and/or an abiotic carrier material (as described herein) in a nutrient mixture (as described herein). In embodiments, the nutrient mixture can comprise a carbon-containing source (to provide energy and carbon), a source of nitrogen, and other nutrients. In embodiments, the carrier material can comprise a material that is porous and/or has a high surface area to hold the nutrients and water in a dispersed form which allows access by a metabolization source (as described herein). In embodiments, the carrier material can allow for aeration if the metabolization source requires or benefits from aeration. In embodiments, preparation can depend upon the solubility of the carbon source. For example, a water soluble carbon source can be dissolved in water. For example, a non-water soluble carbon source can be liquified by heating. In all embodiments, ingredients can be homogenously dispersed. In an embodiment, the substrate can be sterilized prior to inoculation with the metabolization source. For example, the sterilization procedure can comprise autoclaving the substrate.

Aspects of the invention are drawn towards using non-biomass and/or abiotic matter to create a food source. In embodiments, non-biomass and/or abiotic feedstock can be subjected to energy to create an organic feedstock. For example, the abiotic feedstock can comprise CO₂, H₂O, N₂, or a combination thereof. For example, the non-biomass feedstock can comprise a non-biomass carbon source, a non-biomass nitrogen source, and a non-biomass hydrogen source. For example, the non-biomass carbon source can comprise hydrocarbons, petroleum, petroleum jelly, mineral oil (baby oil), paraffin or a combination thereof. In embodiments, the energy source can be solar or non-solar. For example, the non-solar energy source can comprise nuclear energy, wind energy, geothermal energy, or hydropower.

In embodiments substrates can be created by mixing all the ingredients together: creating a solution of the hydrocarbon and other nutrients in water, and, mix with the solid, and sterilize at either about 100° C. or about 121° C. In cases when dissolving in water is not possible, such as the alkanes, we create emulsions. There can be re-mixing after sterilization.

In some embodiments, a feed/fast approach can be beneficial.

### Kits

Aspects of the invention are directed towards kits comprising non-biomass food sources. Aspects of the invention are directed towards kits comprising a non-photosynthetic food system or components thereof and instructions for use thereof. In embodiments the kit can comprise a nutrient cultivating substrate, a non-biomass nutrient mixture, a metabolization source, or any combination thereof. The kit can further comprise instructions for use thereof. In some embodiments, the metabolization source will be provided as spores.

### EXAMPLES

Examples are provided below to facilitate a more complete understanding of the invention. The following examples illustrate the exemplary modes of making and practicing the invention. However, the scope of the invention is not limited to specific embodiments disclosed in these Examples, which are for purposes of illustration only, since alternative methods can be utilized to obtain similar results.

### Example 1

### Example 1

### Introduction

There is a straightforward proportional relationship between the global population and humanity's total food caloric need. For the entirety of human history to present day this caloric need has fundamentally and without exception been met by photosynthetic biomass-irrespective of details such as whether the calories come from edible plants, fish, game, domesticated animals, etc. The vast majority (˜96%) of global caloric needs are met by agriculture and require correspondingly vast areas of arable land, supplanting natural ecosystems. Notably, even the relatively small fraction (<5%) of the caloric needs met by fishing has already caused and continues to cause significant ecological damage.

A review of the literature reveals that the minimum cultivated land area needed to feed one person on a fully vegetarian diet is ˜0.13 ha.(Peters et al., 2016) A standard U.S. diet requires much more land—˜1.1 ha (Peters). It is therefore a matter of arithmetic that feeding the U.S. population requires 13 to 12 of the U.S. land area, specifically agricultural land. Indeed, the U.S. dedicates fully 50% of the land area to agriculture. Globally, the number is of the same order of magnitude, around 38%. Large as it is, this fraction does not fully convey the level of ecosystem appropriation. When we subtract deserts and mountains from the planet's total land area, agriculture occupies 75% of the remainder. These are staggering numbers.

In the food context and from an energy flow perspective, photosynthesis can be viewed as a biochemical energy conversion process that collects incident solar radiation and convers it to biomass, some of which can be more or less directly consumed by humans, much of the rest by livestock. In the same context, land use represents the solar energy collection area for a solar-to-food conversion process. Solar collection is, of course, not sufficient. The land area dedicated to agriculture is ‘agricultural land’, such as arable land (land capable of being ploughed and used to grow crops), land used as pasture and grazed range, and land under permanent crops-all of which share the common characteristic of being able to support relevant photosynthetic plants. As such, this land is typically also most suitable to support rich ecosystems, as indeed it has in the past. The reverse is largely true of the remaining land, a substantial fraction of which are deserts-some of them formed or expanded precisely because excessive agricultural use.

Such planetary-scale biosphere intervention is not without global consequences. Although it is challenging to directly connect causes and effects, the planetary boundaries framework can help quantify levels of perturbation and shows that Earth's biosphere functional and genetic integrity and land system changes are in or nearing the high-risk zone.

Extensive attempts have been made to estimate the monetary value of services provided by the biosphere, with a 1997 estimate between $16 and $57 trillion, roughly equal to the then global gross domestic product. While the monetary issue is a valuable quantification tool, biosphere destruction is of course far more than a monetary value issue—a robust thriving biosphere is a matter of life and death.

With respect to viable alternatives to business as usual, both theoretical and practical precedent exists for the production of edible materials without photosynthesis. We purposely make the distinction between ‘food’ on the one hand, understood as organisms or their products that humans can (and do) consume, and ‘edible molecules’ on the other hand, which can come from a chemical process. The latter include margarine (i.e. fats) from coal, such as in WW2-era Germany, synthetic amino acids for animal feed supplementation, and numerous synthetic food additives. In particular, the techno-economic merits of synthesizing dietary fats were recently considered in detail. (ref)

We make the above distinction to a great extent because of the increasing understanding of the detrimental health effects of processed and ultra-processed foods. While it is feasible that the many efforts to produce synthetic edible materials are successful and perhaps economical, they can lead to long-term health effects similar to those of ultra-processed foods.

Described herein, we present a photosynthetic alternative: Humanity's caloric and broad nutrient needs can be met by a common, time-tested crops, whose consumption can have beneficial health outcomes, while at the same time decreasing key environmental stressors on the biosphere by orders of magnitude.

Without wishing to be bound by theory, this can address food security, food systems for a changing climate, overall crop sustainability, sustainable nutrition, urban agriculture, and water-conscious food production, as well as in the context of United Nations Sustainable Development Goals (SDGs), such as SDG 2, SDG 3, and SDG 15.

We approach this with a historic perspective in mind. A century ago food production was reaching the chemical kinetics limits of biological nitrogen fixation, owing to the energy barrier of breaking the triple bond of gas phase nitrogen (˜1 MJ/mol_{N2}). A technological breakthrough in synthetic nitrogen fixation, specifically through ammonia-based fertilizers and the Haber-Bosch process, resolved this significant issue, and a growing human population (increasing roughly fourfold over the last century) continued to source most of their nutrition from the same well-established staple crops by suitably amending soil with industrially fixed nitrogen and with other necessary minerals (also industrially produced).

In answering the question of a viable food alternative to photosynthesis we look at three items: total land area, arable land, and water input, as primarily relevant to the impact of food production on the biosphere. We show in the analysis and experimental results below that the question of a photosynthesis alternative can have an affirmative answer via a chemosynthesis route, specifically in edible fungi grown on abiotic hydrocarbon substrates produced renewably and efficiently on an industrial scale.

### Results

Solar-to-Food Efficiency (STF) The food production rate today, enabled to a great extent by synthetic nitrogen fixation, is not constrained by kinetics, but by the thermodynamics of carbon fixation, i.e. photosynthesis. The root of the thermodynamic challenge lies in hydrogen production from water (the first step in photosynthetic carbon fixation) —a highly endothermic process, requiring a minimum of ˜286 kJ/mol_{H2} or ˜142 MJ/kg_{H2} under ambient conditions. At temperatures of several thousand Kelvin, the water splitting reaction occurs in a single step (thermolysis) and can theoretically proceed with near-unity efficiency. Similarly, injecting energetic electrons (at a minimum of 1.23 V, equivalent to ˜14000 K) into the reaction can also split water efficiently in a single step. Water splitting and carbon fixation into carbohydrates, fats, and protein in plants occur at ambient temperature and in many incremental steps, each of which carries an efficiency penalty.

For specific photosynthetic crops, estimating their STF (η_{STF,photo}) has long been of interest, going as far back as (William Thompson, 1852), as well as more recently (Monteith, 1972)(Liu et al., 2023). Crop efficiency follows from their yield and the specific energy of the crop (e_{PH}), as well as the corresponding solar resource, specifically the annual global horizontal irradiance (GHI) for a given cropland locale:

$${η}_{STF , photo} = {e}_{PH} \cdot Y / GHI \qquad ( 1 )$$

Table 1 shows the STF efficiency of major (photosynthetic) crops in nations leading the production of these crops—and therefore a good representation of the recent weighted global average. Immediately evident in Table 1 is that this STF efficiency is (still) exceedingly low by any energy conversion standard. Such a low STF efficiency lies at the source of the environmental and societal challenges of food production. We emphasize that this STF efficiency value is not the solar-to-biomass efficiency of photosynthesis, which for staple crops is ˜1%, and can be higher under controlled circumstances, but the real-world average efficiency with which staple crops worldwide convert solar radiation into edible calories.

TABLE 1
STF efficiency of selected photosynthetic crops.

| | | GHI | Crop Yield | |
|---|---|---|---|---|
| Crop | Country | kWh/m2/y | kg/ha | STF Efficiency |
| Rice | China | 1400 | 7137 | 0.0771% |
| | India | 1700 | 2809 | 0.0250% |
| | Bangladesh | 1600 | 4720 | 0.0446% |
| | Indonesia | 1800 | 4750 | 0.0399% |
| Wheat | China | 1400 | 5900 | 0.0647% |
| | India | 1700 | 3500 | 0.0316% |
| | Russia | 1200 | 3200 | 0.0409% |
| | United States | 1400 | 3400 | 0.0373% |

An illustrative way of putting the SFT efficiency from Table 1 into perspective is to consider the solar input necessary to sustain a person, with a 100 W metabolism. An STF efficiency of 0.05% makes the required solar input per person (on a vegetarian staple-crop diet) 200,000 W. The solar input for a standard U.S. diet is far higher: 2 MW. In other words, the standard U.S. diet operates at a solar-to-food efficiency of an abysmal ˜0.005%.
It is of course expected that crop yields and STF efficiencies will continue to grow in the future, as they already have over many decades. Nonetheless, it is questionable to the point of impossibility whether such growth can extend tenfold or hundredfold. Turning to STF of fungi efficiency as a staple crop, we focus on white rot fungi (WRF), a type that primarily includes agaricomycetes. Hundreds of WRF species are edible and dozens are either readily cultivated and commercially grown or commercially harvested wild. Gastronomically well-known and prized of WRF include shiitake (Lentinula edodes), common oyster mushroom (Pleurotus ostreatus), blue oyster mushroom (P. columbinus), summer oyster mushroom (P. pulmonarius), aspen oyster mushroom, (P. populinus), king oyster mushroom (P. eryngii), turkey tail (Trametes versicolor), and maitake (Grifola frondosa), to name some.
In addition to being well-established and often prized foods with excellent nutritional profiles, WRF are also unique in their ability to break down lignin and incorporate it into their biomass. Because of this ability, WRF have been explored for mycoremediation applications, focused on removing organic pollutants from the environment. This ability to break down lignin and other hydrocarbons is precisely of interest here, as an indicator of the feasibility of breaking down and incorporating into their biomass hydrocarbon substrates.
In estimating the STF energy efficiency of WRF, there are two main factors to consider: the STF efficiency of producing energetic chemicals, such as hydrocarbons, for fungal substrates (η_{STHC}) that could replace biomass, and the feed-to-food efficiency with which WRF can convert these energetic substrates to food calories (η_{FTF,WRF})

$${η}_{STF , WRF} = {η}_{STHC} \cdot {η}_{FTF , WRF} \qquad ( 2 )$$

We use solar as the primary energy source for direct comparison to photosynthesis, without excluding other options, such as wind, geothermal, nuclear, etc. We do not, however, consider fungi grown on photosynthetic biomass, as this established approach does not address relevant environmental impact issues of food production—namely the immense fertile land area that photosynthetic carbon fixation requires.

To estimate the efficiency for industrial-scale hydrocarbon production, and without going into excessive detail beyond the intended scope of the work, we consider mature technologies and well-understood hydrocarbon production pathways. One such representative pathway consists of water and CO₂ electrolysis to produce hydrogen (H₂) and carbon monoxide (CO) and subsequent Fischer-Tropsch conversion to alkanes, here using normal decane (n-decane) as an example:

$${H}_{2} O \to {H}_{2} + 1 / 2 {O}_{2} , {CO}_{2} \to CO + 1 / 2 {O}_{2} , \qquad ( 3 )$$

$$10 {CO}_{( g )} + 21 {H}_{2 ( g )} \to {C}_{10} {H}_{22} + 10 {H}_{2} {O}_{( g )} \qquad ( 4 )$$

The reaction exotherm for Eq. 4 is Q_{FT}=1659 kJ/mol, leaving 81% of the original H₂ and CO formation enthalpy in the n-decane product. The corresponding solar-to-hydrocarbon efficiency follows from the efficiency of the component processes. Taking commercial photovoltaic (PV) efficiency (2024) as η_{PV}=24%, solid oxide water and CO₂ electrolysis efficiency η_{SOEC}=90%, and FT efficiency (based on Q_{FT} from Eq. 4) η_{FT}=81%, we readily arrive to a solar-to-hydrocarbon efficiency:

$${η}_{STHC} = 24 \% \cdot 90 \% \cdot 81 \% \approx 18 \% . \qquad ( 5 )$$

In the above we do not consider, DC/AC/DC conversion and transmission losses, under the simplified assumption that chemical plants producing hydrocarbons from solar energy will be co-located with solar farms, much as various smelting plants were (and still are) co-located with power plants. Note also that PV conversion is the lowest efficiency component in Eq. 5, and the electricity (DC) conversion efficiency to hydrocarbons (again, using n-decane as an example) is η_{DC-HC}˜73%.

There are no reports in the literature documenting the cultivation of edible fungi (WRF or otherwise) on abiotic hydrocarbon substrates, and consequently no data on the energy conversion efficiency for the process. To estimate the feed-to-food energy conversion efficiency for WRF (η_{FTF,WRF}) we therefore start with data for well-established wood-based substrates as a proxy:

$${η}_{FTF , WRF} = \frac{BE \cdot {e}_{WRF}}{{e}_{wood}} . \qquad ( 6 )$$

Here, BE is the biological efficiency, a typical measure in mycology, defined as the mass of fresh fruit (collected over multiple flushes) divided by the mass of the dry substrate. BE varies with species, strain, substrate and other cultivation factors, often ranging between 100% and 200%. The energy value of fresh WRF fruit, eWRF, ranges approximately between 1.7 MJ/kg and 1.9 MJ/kg, whereas for wood pel-lets the typical energy value is e_{wood}˜14.4-20.3 MJ/kg. Assuming BE=100%-200%, Eq. 6 gives gives η_{FTF,WRF}≈8%-26%.

Under these assumptions and putting back the values from Eq. 5 and Eq. 6 into Eq. 2, we arrive to range of values for η_{STF,WRF}=1.65%-3.69%, approximately 20-150 times higher than that of photosyn-thetic staple crops from Table 1.

These energy conversion efficiency values indicate that the land area needed per food calorie could be substantially lower for WRF than is photosynthesis. Moreover, the land area need not be arable land but, for example, the land area for a solar PV installation in sunny desert regions.

The key remaining question is whether edible fungi (WRF or others) can be grown on synthetic hydro-carbons and if so, with what energy efficiency. To begin answer this question, we conducted preliminary experiments focusing on the mycelium substrate colonization stage as an early feasibility indicator.

Mycelium propagation on synthetic hydrocarbons FIG. 1 (top row) shows the successful colonization of a non-biomass substrate by multiple Pleurotus species and strains, with two pearl oyster mushroom strains centered in the images. Substrates were inoculated with two mycelium-colonized rye grains per strain. The substrate comprises about 1.6% 1,3 butanediol solution in 25 mL water, supported on 1.2 g of open-cell polyurethane foam, where the percentage refers to the mass of carbon in the diol per mass water. For example, the total initial amount of 1,3 butanediol in the sample in FIG. 1 was 0.77 ml. The nitrogen source can be urea, at a C/N ratio of about 60, with nutrients also comprising diammonium phosphate, muriate of potash, or any combination thereof.

Evident in FIG. 1 is that colonization reaches its maximum extent relatively quickly (approximately day 50), after which follows a stagnation and then mild dwindling period (days 50-96). We interpreted this stagnation and dwindling as evidence of feed depletion and tested that this by replenishing with two additions of a 2% 1,3 butanediol solution (days 98 and 105). Shortly after these additions the mycelium expanded again (day 119), supporting the finding.

An otherwise identical control sample excluding the butanediol (FIG. 1, bottom row) extends hyphae outward from the rye grain inoculant but then shows no signs of colonization.

FIG. 2 shows a similar experiment, using a 2% 1,4 butanediol solution as the energy source, with a similar outcome: initial growth, stagnation, additional growth upon feed addition. The corresponding control substrate also shows a null result, similar to that in FIG. 1.

Similarly prepared cultures of Phoenix Oyster (Pleurotus pulmonarius), Pearl Oyster (Pleurotus ostreatus), Wood Ear (Auricularia auricula-judae), Turkey Tail (Trametes versicolor), and Maitake (Grifola frondosa) on substrates including propylene glycol, 1,3 propanediol, 1,5 pentanediol, 1,6 hexanediol, 1,2,6 hexanetriol, 1,2,4-butanetriol, straight chain alkanes, and succinic and adipic acid, have all shown the same key outcomes:

Mycelium growth and colonization of the hydrocarbon substrate and lack of colonization of the control substrate, and; rejuvenated growth following hydrocarbon solution additions to stagnating or dwindling cultures.

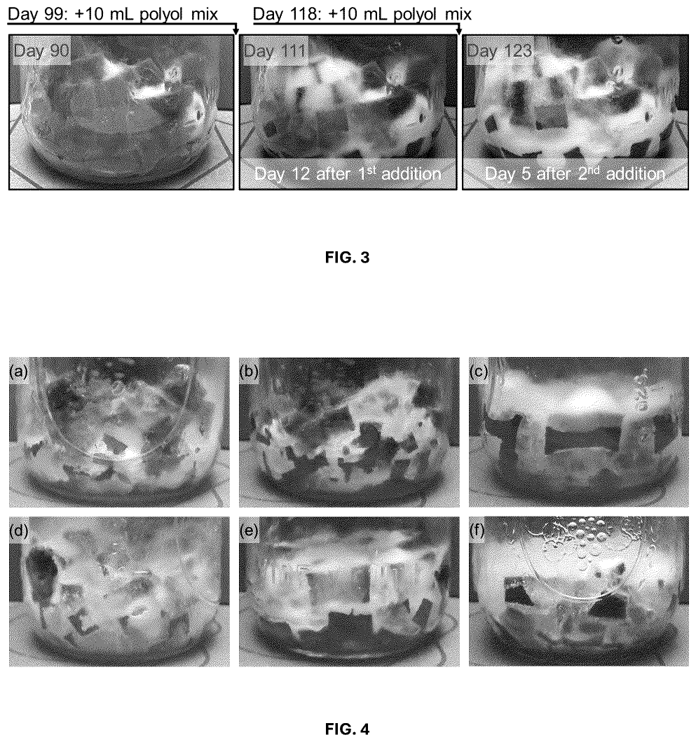

In an additional approach, we monitored at length a control sample i.e., one with all the substrate ingredients—sans the hydrocarbon—and confirming inactivity, followed by addition of a hydrocarbon solution. FIG. 3 shows the rather stunning results of one such experiment, where the original sample does not colonize for nearly 100 days, but then colonizes significantly over just 12 days following a hydrocarbon solution addition, with further growth extent and density following a second addition.

The results described above were reproducible across many species/strain/substrate combinations. FIG. 4 shows several of the dozens of successfully colonized hydrocarbon-based substrates. In all cases the corresponding control substrates showed no signs of colonization.

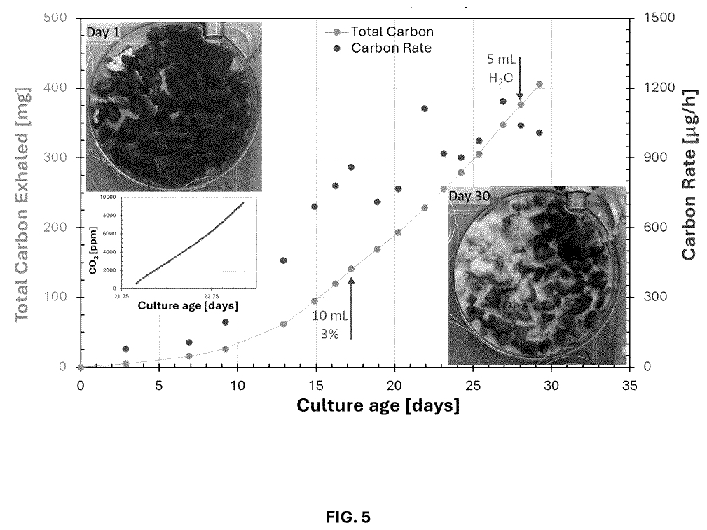

The strong evidence of mycelial growth, implying significant biomass production (i.e., carbohydrates, fats, and protein) from hydrocarbons, created the need to experimentally quantify hydrocarbon decomposition by the mycelium. To this end we used measurements of CO₂ production in a sealed 6.5 L container (Atlas Scientific non-dispersive infrared sensor EZO-CO2, 0-10,000 ppm range) concurrently with imaging mycelium growth (FIG. 5).

The substrate for the experiment in FIG. 5 consisted of 50 mL of 3% 1,3-propanediol supported on 1.2 g of polyurethane foam. The inoculant consisted solely of several pieces of already colonized polyurethane foam, with no other biomass (visible in the upper left quadrant of the Day 1 inset image).

The total exhaled carbon and rate in FIG. 5 derive from raw CO₂ concentration (x_{CO2}) data, such as shown in the Day 22 inset, where x_{CO2} increases from ambient to near the sensor limit in about 30 h. To stay within sensor limits, the chamber was periodically flushed with air passed through a filter.

The significantly colonized substrate is shown in the Day 30 inset, with the mycelium having exhaled 430 mg of carbon (˜907 mg of propanediol) at that point.

While the mycelium growth is strikingly evident in the images, we nonetheless examined the culture microscopically and confirmed that there is no evidence of other organisms that can have consumed the diol.

### DISCUSSION

Our experiments provide conclusive evidence that fungal biomass, and therefore carbohydrates, fats, and protein can grow on hydrocarbons synthetically synthesizable from carbon dioxide and water, using arable land-independent primary energy sources. Further, the variety of edible fungi species and hydrocarbon substrates showing growth success represent a substantial fraction of the tested combinations, indicating that the observed growth is unlikely to be a rarity. Rather, we can infer that many of species of edible fungi can grow on synthetic hydrocarbons, especially after appropriate artificial selection or modification.

With some due caution, we can consider that our original question about a photosynthesis alternative can have an affirmative answer in fungi-based chemosynthesis. With that affirmative answer in mind, we consider some of the implications, starting with land use.

Land use follows from the required input power. The total primary power requirement to feed the U.S. population at 340 million, consuming food at the equivalent of 100 W per person, gives a total (food) power requirement of 34 GW, and a corresponding nutrient energy flow Ėₙᵤₜᵣ=227 GW (using a nominal η_{FTF,WRF}=15%). Considering the annual power generation of solar farms in good solar locations, such as in the U.S. southwest, ˜0.15 TWh/km²/year), and conversion efficiencies calculated earlier (esp. η_{DC-HC}˜73%), we arrive to a value for the land area of merely ˜18,000 km² to generate all the power needed to feed the totality of the U.S. population via the chemosynthesis/fungi route.

For perspective, this required land area pales in comparison to the total agricultural area in the U.S., which is around 1.2 billion acres (4,850,000 km²), or ˜270-fold larger. The chemosynthetic/fungi route land area is also far smaller than the land devoted to agriculture in the solar-rich states (CA, AZ, NM, TX), which is ˜786,000 km², or ˜44-fold larger.

Another worthwhile comparison is with the land area needed to feed the U.S. population on a vegetarian diet, which follows from the minimum crop area to feed a person (0.13 ha), for a total of ˜442,000 km² or roughly 16-fold more than the chemosynthesis/fungi route.

These staggering ratios also give confidence that whatever values η_{FTF,WRF} assumes in the 5-25% range, or reasonable inefficiencies the system inevitably develops, will not substantially change the overall land use picture.

Importantly, none of the solar PV area needs to be arable land (although dual use approaches, such as agrivoltaics are an option), and would not require irrigation, tilling, fertilization, or pest control. Facilities for CO₂ (and potentially water) capture from the atmosphere and for producing nutrient hydrocarbon(s) and mixtures would require some additional non-arable land area, small compared to that for solar farms, altogether making the possible land need decrease ˜90%, and arable land fully 100% compared to the existing photosynthetic food system.

A related question is that of transporting nutrient hydrocarbons from production areas to points of food production and consumption, largely in and near urban population centers, where ˜85% of the U.S. population resides. To address this question, we turn to the hydrocarbon nutrients flow rate (\dot{M}ₙᵤₜᵣ) to food production locations. This flow can be estimated from Ėₙᵤₜᵣ and using again the n-decane example and its energy value of 44 MJ/kg, yielding \dot{M}ₙᵤₜᵣ=5,045 kg/s. Expressed in customary units, this flow rate is \dot{M}ₙᵤₜᵣ=3.2 Mbpd, or ˜16% of the U.S. daily petroleum consumption (of which gasoline is ˜8.9 Mbpd), indicating that the logistics would be quite ordinary.

To give the above large numbers some relatable perspective, we can also express the nutrient flow rate per capita-1.3 kg/day. For comparison, the daily per capita usage of gasoline in the U.S. is 4.2 L/day, and of household water 310 L/day, again leaving little doubt that delivering the needed quantities of nutrient hydrocarbons to points of consumption is well within the ordinary.

Remaining discussion areas: water, nutrition/health profile of fungi, food security and resilience against adverse events and long-term climate change effects, especially droughts and new pathogens, climate mitigation and carbon storage, sustainable forestry, ecosystem restoration, food diversity, connection with existing and future clean fuel/energy/chemical systems; Mushrooms gaining prominence, literature, key areas of interest

### Freshwater Withdrawals of Foods Per 1000 Kilocalories

At 15 L/kg, water consumption for mushroom cultivation (including substrate preparation, ambient humidification, and washing) pales in comparison to all staple crops (e.g. ˜300 L/kg for potatoes, ˜1800 L/kg for wheat, and ˜2500 L/kg for rice). Much like with land, the resource efficiency potential is enormous.

### REFERENCES CITED HEREIN

1. www.nationalgeographic.com/what-the-world-eats/
2. Foley, J. A. et al. Global consequences of land use. Science 309, 570-574 (2005).
3. Newbold, T. et al. Global effects of land use on local terrestrial biodiversity. Nature 520, 45-50 (2015).
4. Hong, C. et al. Global and regional drivers of land-use emissions in 1961-2017. Nature 589, 554-561 (2021).
5. Rockström et al., A safe operating space for humanity. Nature 461, 472-475 (2009).
6. Steffen, et al., Planetary boundaries: Guiding human development on a changing planet. Science 347, 1259855 (2015).
7. doi.org/10.1126/sciadv.adh2458
8. The value of the world's ecosystem services and natural capital Robert Costanza et al., conservationtools-production.s3.amazonaws.com/library_item_files/1043/961/The_value_of_the_world_s_ecosyst em_services_and_natural_capital.pdf?X-Amz-Algorithm=AWS4-HMAC-SHA256&X-Amz-Credential=AKIAIQFJLILYGVDR4AMQ %2F20240308%2Fus-east-10%2Fs3%2Faws4_request&X-Amz-Date=20240308T172322Z&X-Amz-Expires=3600&X-Amz-SignedHeaders=host&X-Amz-Signature=3ef7aela17b4c253819ba183f6bfc724784b970a4cdd8e4d23e31808a4004a55
9. Stranges, A. N. A history of the Fischer-Tropsch synthesis in Germany 1926-45. Stud. Surf Sci. Catal. 163, 1-27 (2007).
10. Imhausen, A. Die Fettsaure-Synthese und ihre Bedeutung fur die Sicherung der deutschen Fettversorgung. Kolloid-Z. 103, 105-108 (1943).
11. Drauz, K. et al. Amino acids. Ullmann's Encycl. Ind. Chem. doi.org/10.1002/14356007.a02_057.pub2 (2007).
12. Davis et al., Nature Sustainability volume 7, pages 90-95 (2024).
13. Schwartz et al., Systems biology-guided understanding of white-rot fungi for biotechnological applications: A review.
14. Li et al., Reviewing the world's edible mushroom species: A new evidence-based classification system. PMID: 33599116. DOI: 10.1111/1541-4337.12708.
15. Carlos del Cerro et al., Intracellular pathways for lignin catabolism in white-rot fungi, PNAS, Feb. 23, 2021, 118 (9) e2017381118, doi.org/10.1073/pnas.2017381118.
16. www.nrel.gov/pv/module-efficiency.html
17. www.fuelcellenergy.com
18. Census eta-publications.lbl.gov/sites/default/files/land_requirements_for_utility-scale_pv.pdf

### Example 2

The production of edible materials without photosynthesis. In particular, a photosynthesis alternative via a chemosynthesis route such as edible fungi grown on abiotic hydrocarbon substrates produced renewably and efficiently on an industrial scale. The production of un-processed edible materials without photosynthesis is more economical, provides beneficial health outcomes (relative to processed materials), and decreases key environmental stressors on the biosphere by orders of magnitude.

### Non-Limiting, Exciting Features Described Herein:

successful colonization of a non-biomass substrate by multiple Pleurotus species and strains, with two pearl oyster mushroom strains
substrate consists of a 2% 1,3 butanediol solution in water, supported on 1.2 g of open-cell poly-urethane foam, where the percentage refers to the mass of carbon in the diol per mass water
nitrogen source is urea, at a C/N ratio of 60
substrates including propylene glycol, 1,3 propanediol, 1,5 pentanediol, 1,6 hexanediol, 1,2,6 hexanetriol, 1,2,4-butanetriol, straight chain alkanes, and succinic and adipic acid, have all shown the same key outcome

### Example 3

### Non-Limiting, Exemplary Emulsion Experimental Preparation Procedure

Described herein is a procedure to prepare a non-biomass nutrient mixture and substrate for mycelium/mushroom growth, and then to inoculate the substrate with mycelium.
1. Boil 200 g water in an electric kettle. Add to large beaker (at least 600 mL) once it cools to 60° C. Measure the following ingredients (baby oil, nutrient solution, behtrimonium methosulfate cetearyl alcohol (BTMS-25), and ferrous sulfate) while water is cooling. Add and blend these ingredients while the water is still warm (45-60° C.).
2. Measure 6 g mineral oil (e.g., Johnson's® baby oil) into a 50 mL beaker. Pour into the beaker with the water, near but not touching the sides.
3. Shake closed vial of concentrated nutrient solution until no particles are visible, then add 1.8497 g to the mineral oil-water mix.
a. To make concentrated nutrient solution, mix in a 50 mL beaker:
   i. 7.4318 g water
   ii. 0.3571 g vanillin powder
   iii. 1.6813 g micronutrient mix fertilizer (e.g., from Jackpot®) —comprising boron, calcium, copper, iron, magnesium, manganese, and zinc.
   iv. 0.4568 g 0-0-60 muriate of potash (potassium chloride)
   v. 0.0829 g L. D. Carlson diammonium phosphate
   vi. 1 g 46-0-0 urea
b. Heat at 40° C. and spin at 600 rpm on stir plate until solution forms, adding water to replace evaporated water.
4. Add 0.6 g BTMS-25 (e.g., from Lisse Cosmetics®), crushed and chopped into ˜1 mm³-sized pieces.
5. Add 0.24 g ferrous sulfate heptahydrate (e.g., from Greenway Biotech®).
6. Using an AuxCusio immersion blender with a whisk attachment on power setting II, blend for 2 minutes at a time, until emulsion is stable (does not separate into multiple layers) for at least 1 minute. Blending can add up to about 12 cumulative minutes. Unplug the blender and let it cool down if it starts to heat excessively.
7. Blend full emulsion for a final 2 minutes, then immediately pour equal amounts (50 g each) of emulsion into four medium-sized beakers, 200-300 mL.
8. If using white polyurethane foam, place 8 g foam into each of four quart-size mason jars. If using black foam, cut polyurethane foam (e.g., from Fabbay®) into 1″×0.5″×0.5″ prisms and place 4 g foam into each of four quart-size mason jars.
9. Blend a 50 g emulsion for 1 minute, then immediately pour into a mason jar of foam. Use the blade attachment of the immersion blender (not attached to the blender) to press the foam into the bottom of the jar and soak up the emulsion. Use tongs or tweezers to mix foam up, and press again. Repeat mixing and pressing until the foam has soaked up the emulsion.
10. Repeat step 9 with the other 3 emulsions and mason jars.
11. Use a metal hole punch to punch 3 holes in an equilateral triangular shape in the mason jars' lids. Place the lids on the jars so that the seals are face-up. Add 90 mm mycological mason jar filters, shiny side face-up, on top of the lids. Close each jar with the lid rings with a 90° turn, so that the lid setup is closed, but not tight, on the jar. Cover each with a 4.5″ diameter circle of aluminum foil.
12. Boil jars for 30 minutes.
13. Place jars in front of flow hood for at least 2 hours. If emulsion has drained to the bottom, strain into a separate jar placed on a scale in front of the flow hood. Measure and record amount each emulsion has drained.
14. Inoculate jars with mycelium

Those skilled in the art will recognize, or be able to ascertain, using no more than routine experimentation, numerous equivalents to the specific substances and procedures described herein. Such equivalents are considered to be within the scope of this invention and are covered by the following claims.

### EQUIVALENTS

Those skilled in the art will recognize, or be able to ascertain, using no more than routine experimentation, numerous equivalents to the specific substances and procedures described herein. Such equivalents are considered to be within the scope of this invention and are covered by the following claims.

What is claimed is:

1. An abiotic, nutrient-cultivating substrate comprising an abiotic carrier material and an abiotic nutrient mixture, wherein the abiotic nutrient mixture comprises:
about 15 to about 65 grams of water per gram of carrier material;
about 0.5% to about 10% of at least one abiotic carbon source per gram of water, wherein the abiotic carbon source is selected from the group consisting of a polyol, a polycarboxylic acid, an alkane emulsion, or a combination thereof;
an abiotic nitrogen source present in a ratio of about 5:1 with the abiotic carbon source;
a micronutrient source; and
an agent and/or solution capable of maintaining the substrate at a pH of about 6 to about 8.

2. The substrate of claim 1, wherein the abiotic carrier material comprises a porous material.

3. The substrate of claim 2, wherein the porous material comprises mineral wool, zeolite, mesoporous metal oxides, fiberglass, perlite, vermiculite, a synthetic polymer, a polymer foam, or a combination thereof.

4. The substrate of claim 3, wherein the polymer foam is an open cell foam.

5. The substrate of claim 4, wherein the open cell foam comprises a polyurethane foam, a polyethylene foam, a polyvinylchloride foam, or a combination thereof.

6. The substrate of claim 1, wherein the polyol is selected from the group consisting of a polymeric polyol, a sugar alcohol, a diol, a triol, a tetrol, or any combination thereof.

7. The substrate of claim 1, wherein the polyol is selected from the group consisting of 1,3-propanediol, 1,3-butanediol, 1,4-butanediol, 1,5-pentanediol, 1,2,6-hexanetriol, propylene glycol, or a combination thereof.

8. The substrate of claim 1, wherein the polycarboxylic acid is selected from the group consisting of succinic acid, adipic acid, or a combination thereof.

9. The substrate of claim 1, wherein the alkane emulsion comprises mixture of alkanes and at least one emulsifier.

10. The substrate of claim 9, wherein the mixture of alkanes is selected from the group consisting of paraffin, mineral oil, or a combination thereof.

11. The substrate of claim 9, wherein the emulsifier comprises Behentrimonium Methosulfate Cetearyl Alcohol (BTMS 25).

12. The substrate of claim 1, wherein the nitrogen source comprises urea.

13. The substrate of claim 1, wherein the micronutrient source comprises an iron source, a phosphorus source, a calcium source, a potassium source, a magnesium source, a zinc source, a copper source, a manganese source, a boron source, or a combination thereof.

14. A nutrient production system comprising the abiotic carrier material of claim 1, the abiotic nutrient mixture of claim 1, and a metabolization source.

15. The system of claim 14, wherein the metabolization source comprises source comprises a saprophytic organism.

16. The system of claim 15, wherein the saprophytic organism comprises mold, mushroom, yeast, penicillium, and mucor, or a combination thereof.

17. The system of claim 16, wherein the mushroom is selected from the group consisting of Pleurotus ostreatus, Pleurotus pulmonarius, Pleurotus populinus, Ganoderma lucidum, Trametes versicolor, Grifola frondosa, Pleurotus columbinus, Pleurotus diamor, Pleurotus eryngii, Amillaria gallica, Cantharellus cibarius, Lentinula edodes, Auricularia auricula, Armillaria mellea, Polyporus squamosus, Hericium erinaceus, Polyporus umbellatus, Laetiporus sulphureus, or a combination thereof.

18. A method of producing an edible material without photosynthesis, the method comprising:
producing the nutrient mixture of claim 1;
soaking the abiotic carrier material of claim 1 in the nutrient mixture to create a cultivation substrate; and
cultivating at least one saprophytic organism on the cultivation substrate, wherein the saprophytic organism metabolizes the cultivation substrate to produce a food product.

19. The method of claim 18, wherein the food product comprises the saprophytic organism, a derivative thereof, or a product thereof.

20. The method of claim 19, wherein the derivative or product thereof comprises an oil, a liquid, a gel, a powder, or a combination thereof.
